(19) United States
(12) Patent Application Publication
(10) Pub. No.: US 2008/0251621 A1
(43) Pub. Date: Oct. 16, 2008

(54) Fishing reel mount assembly

(76) Inventor: Charles P. Bingham, Lighthouse Point, FL (US)

Correspondence Address: WILEY HORTON, 215 SOUTH MONROE STREET, 2ND FLOOR, TALLAHASSEE, FL, 32301, US

(21) Appl. No.: 12/158,000

(22) Filed: Jun. 16, 2008

Related U.S. Application Data
(63) Continuation-in-part of application No. 11/436,005, filed on May 17, 2006, now Pat. No. 7,377,070.

(51) Int. Cl. A01K 87/06

(52) U.S. Cl. 242/316; 242/310; 29/558

(57) ABSTRACT

A modified reel and mounting assembly for attaching a fishing reel to a fishing rod. The assembly includes a cutout in the reel which conforms to the surface of the reel seat and an arcuate slot on both ends of the cutout. The cutout in the reel mates with surface of the reel seat, and the seat mounts are received by the arcuate slots. The arcuate slots create a lip which is clamped into place by the clamps of the rod seat. In the preferred embodiment, a clamp bar is also provided for increased stability.

### CROSS-REFERENCES TO RELATED APPLICATIONS

This application is a Continuation-In-Part of U.S. application Ser. No. 11/436,005, filed May 15, 2006. The parent application listed the same inventor.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of fishing reels. More specifically, the present invention comprises a new fishing reel attachment mechanism for attaching a fishing reel to a fishing rod.

2. Description of the Related Art

Many different attachment mechanisms are known for attaching a fishing reel to a fishing rod. The most common attachment mechanism, however, is a foot/seat attachment as illustrated in FIGS. 1, 2A, and 2B. Reel 12 includes foot 26 which is attached to its base (in the orientation of FIG. 1). Typically, foot 26 is attached to reel 12 with bolts, screws, or welding. Reel 12 also includes crank 24 and crank knob 42 which are used to spool the fishing line back into reel 12.

As shown in FIGS. 2A and 2B, reel 12 is attached to a fishing rod by placing foot 26 into rod seat 52 on rod 32. Many different rod seats are known, but common rod seats typically feature a pair of adjustable seat mounts 44 and 46. One common variety utilizes screw-type clamps as illustrated in FIG. 2A and FIG. 2B. Adjustable seat mounts 44 and 46 each have collar 38 and 40 respectively. Generally, reel 12 is attached by inserting leading edge 48 of foot 26 into adjustable seat mount 44 between collar 38 and the surface of reel seat 52. Adjustable seat mount 46 is then advanced along the length of rod 32 by a screwing motion until it locks foot 26 into place (as shown in FIG. 2A). In the example illustrated in FIGS. 2A and 2B, rod 32 has male threads along seat 52, and female threads are used on the inside surface of adjustable seat mounts 44 and 46. Adjustable seat mount 46 and adjustable seat mount 44 clamp foot 26 firmly to rod 32 so that reel 12 cannot move up or down rod 32 or rotate angularly about rod 32. Although screw-type clamps are most common, adjustable seat mounts 44 and 46 may assume many different configurations.

Although this is the most commonly used mechanism for attaching a reel to a rod, the use of a foot/seat attachment mechanism such as shown in FIG. 2A has some negative effects. First, the use of a foot creates displacement between the reel and the rod. When the user applies force to turn crank knob 42, the rod will try to twist. The user must attempt to counteract this twisting force with his or her rod-gripping hand. This may result in premature fatigue to an angler who is fighting a large fish for a long period of time. It also may reduce the angler's sensitivity to the action of the fish.

In addition, a foot is susceptible to bending or breaking from the reel when the fishing line is periodically subjected to large amounts of tension. When the fishing line is placed under tension, the reel is pulled in the direction of the tip of the fishing rod. Over time, these forces can deform the foot or cause the attachment mechanism which attaches the foot to the reel to weaken.

Accordingly it would be desirable to have an attachment mechanism for attaching a fishing reel to a fishing rod that minimizes torque and is less susceptible to failure.

### BRIEF SUMMARY OF THE PRESENT INVENTION

The present invention comprises a modified reel and mounting assembly for attaching a fishing reel to a fishing rod. The assembly includes a cutout in the reel which conforms to the surface of the reel seat and an arcuate slot on both ends of the cutout. The cutout in the reel mates with surface of the reel seat, and the seat mounts are received by the arcuate slots. The arcuate slots create a lip which is clamped into place by the clamps of the rod seat. In the preferred embodiment, a clamp bar is also provided for increased stability.

### BRIEF DESCRIPTION OF THE SEVERAL VIEWS OF THE DRAWINGS

FIG. 1 is a perspective view, showing a prior art reel.

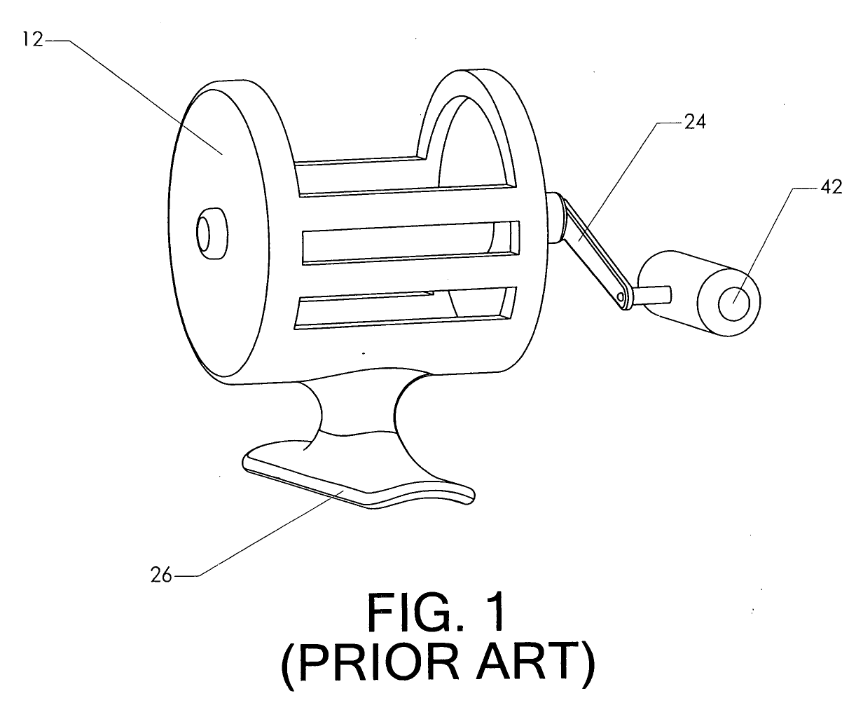

FIG. 2A is a perspective view with a cutaway, showing a prior art reel attachment mechanism.

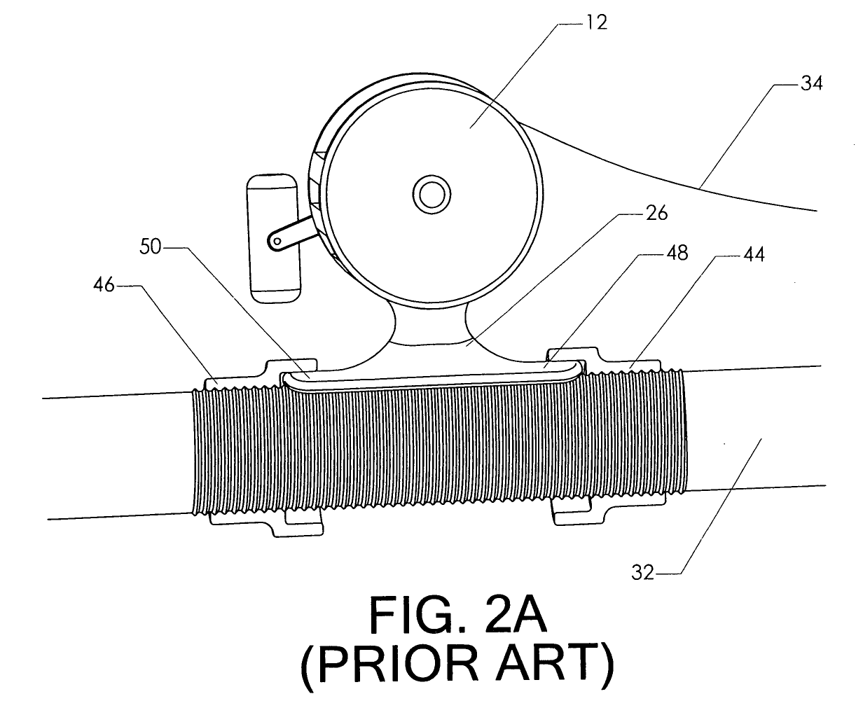

FIG. 2B, is a perspective view, showing a prior art reel attachment mechanism

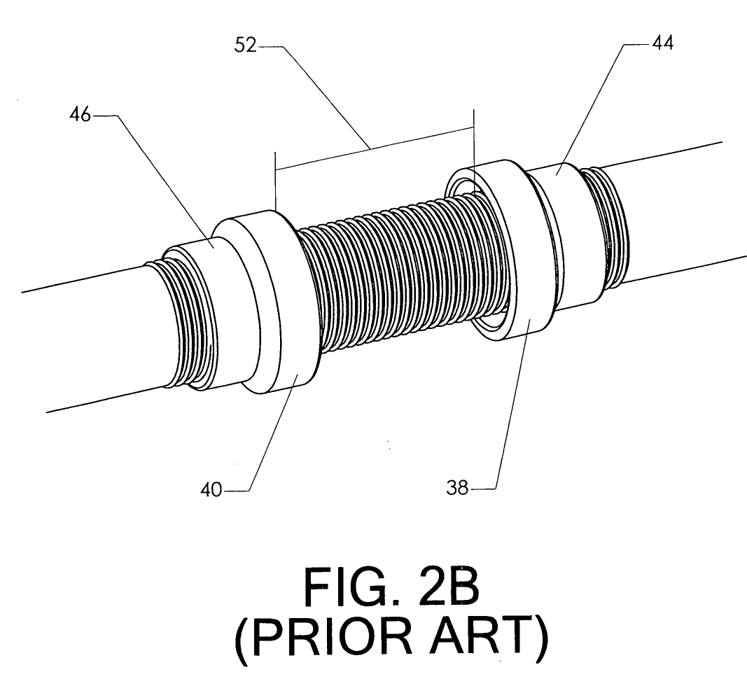

FIG. 3 is a perspective view, showing the present invention.

FIG. 4A is a bottom view, showing the present invention

FIG. 4B is a front view, showing the present invention.

FIG. 5 is a section view, showing the present invention.

FIG. 6 is a perspective view, showing the present invention mounted on a rod.

FIG. 7A is a perspective view, showing an alternate embodiment of the present invention.

FIG. 7B is a section view, showing an alternate embodiment of the present invention.

FIG. 8 is a perspective view, showing an attachment device for attaching a fishing reel to a rod.

FIG. 9 is a perspective view, showing an attachment device for attaching a fishing reel to a rod.

FIG. 10 is a front view, showing the attachment device attached to a fishing reel.

FIG. 11 is a perspective view, showing the attachment device attached to a fishing reel.

FIG. 12 is a side view, showing a fishing reel employing the attachment device attached to a fishing rod.

REFERENCE NUMERALS IN THE DRAWINGS

| | | | |
|---|---|---|---|
| 10 | mount assembly | 12 | reel |
| 14 | clamp bar | 16 | clamp screw |
| 18 | cutout | 20 | cutout |
| 22 | arcuate slot | 24 | crank |
| 26 | foot | 28 | clamp screw hole |
| 30 | lip | 32 | rod |
| 34 | fishing line | 36 | spool |
| 38 | collar | 40 | collar |
| 42 | crank knob | 44 | adjustable seat mount |
| 46 | adjustable seat mount | 48 | leading edge |
| 50 | trailing edge | 52 | reel seat |
| 54 | hexagonal reel seat | 56 | hexagonal cutout |
| 58 | arcuate slot | 60 | adjustable seat mount |
| 62 | adjustable seat mount | 64 | hexagonal collar |
| 66 | hexagonal collar | 68 | clamp bar |
| 70 | hexagonal cutout | 100 | reel attachment device |
| 102 | arcuate slot | 104 | arcuate slot |
| 106 | cylindrical cutout | 108 | bores |
| 110 | curved surface | 112 | bores |
| 114 | spool-facing surface | 116 | counterbores |
| 118 | central axis | 120 | reel |
| 122 | bores | 124 | screws |
| 126 | cutout | 128 | line |
| 130 | rod | 132 | collar |
| 134 | collar | 136 | threaded portion |
| 138 | clamp bar | 140 | bolt |
| 142 | side surface | 144 | spool |
| 146 | spool axis | | |

### DETAILED DESCRIPTION OF THE INVENTION

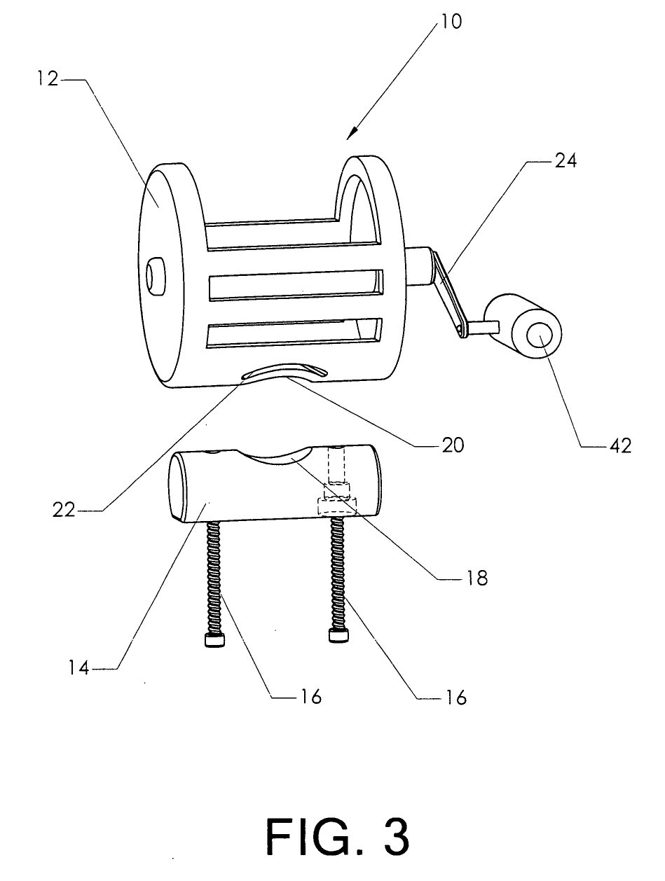

The present invention, mount assembly 10, is illustrated in FIG. 3. Mount assembly 10 generally includes reel 12 and clamp bar 14, which are attached together around a fishing rod when reel 12 is positioned in the reel seat. Reel 12 may be any type of fishing reel. The particular version shown in FIG. 3 is a “conventional” type (as opposed to a spinning type). Reel 12 includes crank 24 and crank knob 42 which are used to spool fishing line back into reel 12 once the line has been unspooled.

Cutout 20 is provided in the surface of reel 12 which faces the reel seat. In the preferred embodiment, cutout 20 is a substantially cylindrical cutout. Cutout 20 may be other shape that would conform to the surface of the reel seat, however. In the preferred embodiment, the diameter of the cutout 20 may be set to accommodate the diameter of the fishing rod that will be used with the fishing reel. Cutout 20 allows reel 12 to be mounted as closely to the fishing rod as possible. This minimizes the twisting torque applied to the rod when the user turns crank 24 since the displacement of the crank-turning force from the fishing rod is minimized. Cutout 20 also creates a more stable attachment by increasing the “contact” surface area between reel 12 and the reel seat. Arcuate slot 22 is included on both ends of cutout 20 so that reel 12 may be mounted to most common fishing rods with seat clamps.

Clamp bar 14 also has cutout 18 to increase “contact” surface area between clamp bar 14 and the surface of the reel seat. Cutout 18 is preferably cylindrical to conform to the surface of most reel seats. A pair of clamp screws 16 are provided to attach clamp bar 14 to reel 12. This allows clamp bar 14 and reel 12 to be tightly clamped around the fishing rod. Clamp bar 14 may also be a simple metal plate that is bent to conform to the surface of the reel seat.

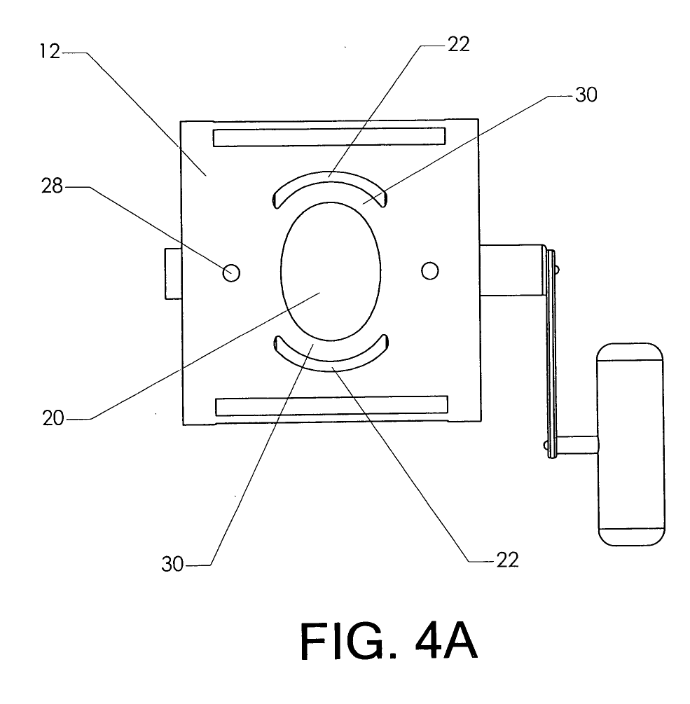

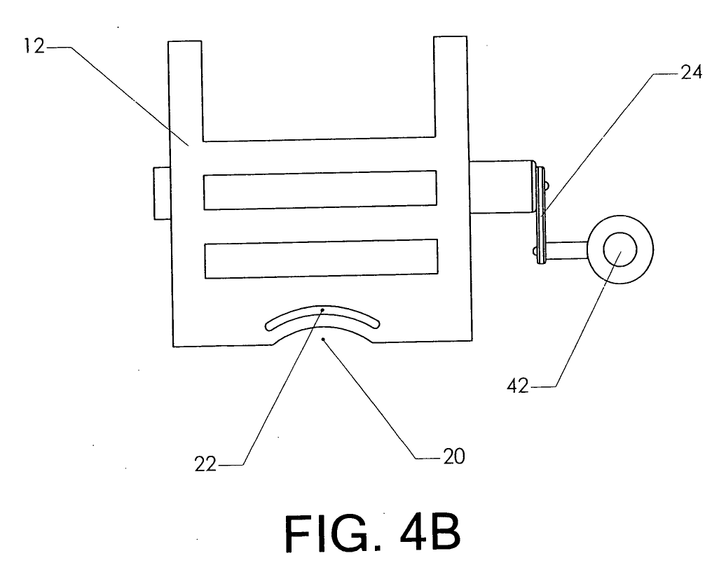

The various cutouts in the surface of reel 12 are shown in greater detail in FIGS. 4A and 4B. FIG. 4A is a bottom view of reel 12, and FIG. 4B is a front view of reel 12. As illustrated in FIGS. 4A and 4B, cylindrical-shaped cutout 20 forms an oval shape in the bottom of reel 12. An arcuate slot 22 is provided on both ends of cutout 20. The combination of cutout 20 and arcuate slot 22 forms lip 30. Clamp screw holes 28 are provided on both sides of cylindrical cutout 20 and are configured to receive the pair of mount screws 16 as shown in FIG. 3.

These “cutouts” may be easily made either by hand machining or by computer controlled machine tools such as a CNC machine. They can also be cast into the reel if the reel body is made by casting. Although the term “cutout” is used frequently throughout this specification to describe these features, it should be understood that these features may also be created using molding, casting or other techniques.

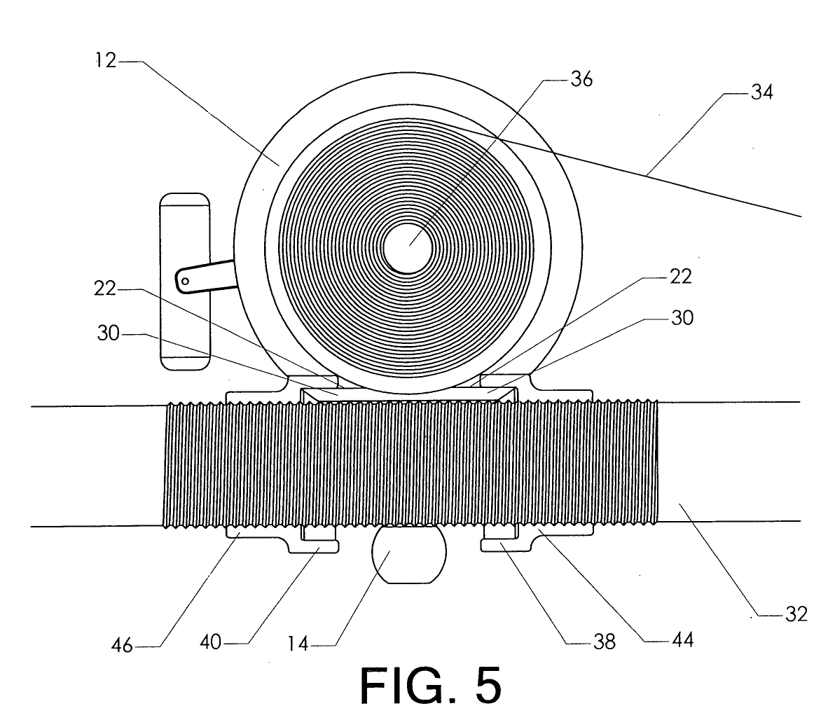

FIG. 5 is a section view illustrating how reel 12 may be attached to a fishing rod. In the present illustration reel 12 is sectioned but not the fishing rod. Reel 12 has fishing line 34 attached to spool 36 and fed through guides (not shown) to the tip of rod 32. Reel 12 is attached to the reel seat between collars 38 and 40 of adjustable seat mounts 44 and 46. Although adjustable seat mount 44 with collar 38 and adjustable seat mount 46 with collar 40 are illustrated in FIG. 5, any type of seat clamp may be used.

To attach reel 12 to the reel seat of rod 32, lip 30 is inserted between adjustable seat mount 44 and rod 32 so that collar 38 of adjustable seat mount 44 is received in the forward arcuate slot 22. Reel 12 is held flush against the reel seat so that the reel seat is maintained within cutout 20. Adjustable seat mount 46 is then rotated about rod 32 so that it travels in the direction of reel 12. As adjustable seat mount 46 nears reel 12, lip 30 is captured between collar 40 of adjustable mount 46 and rod 32. The wall of collar 40 simultaneously enters arcuate slot 22. The user continues to turn adjustable seat mount 46 until reel 12 is firmly clamped between adjustable seat mount 46 and adjustable mount 44. Clamp bar 14 is then positioned on the surface of rod 32 opposite reel 12 and clamp screws 16 are used to attach clamp bar 14 and reel 12 together around rod 32.

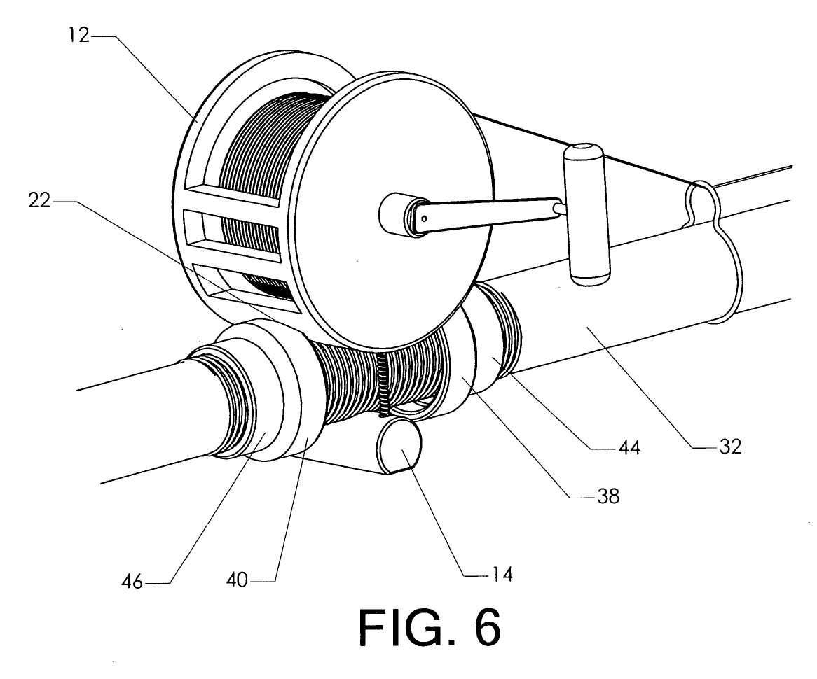

FIG. 6 is a perspective view showing the same assembly. Reel 12 is mounted in the reel seat of rod 32 between adjustable seat mount 44 and adjustable seat mount 46. Reel 12 is also mounted to the reel seat by clamp bar 14 by clamp screws 16.

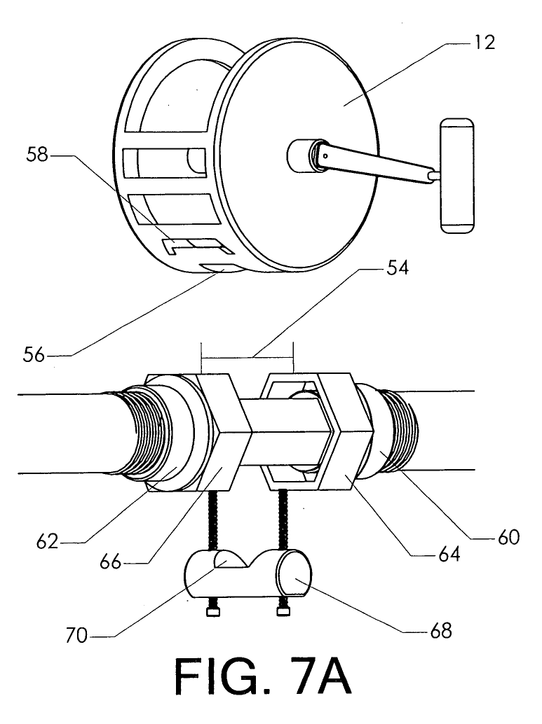

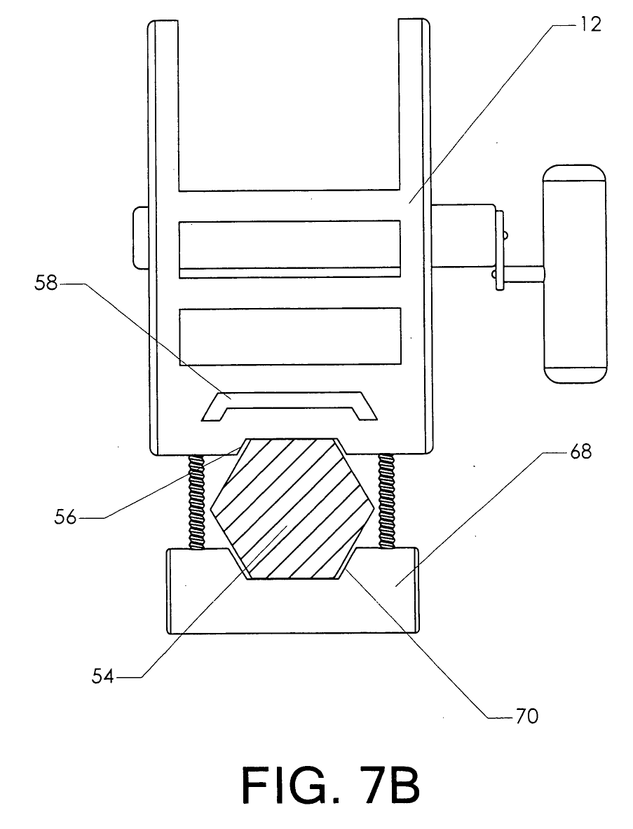

The reader will appreciate that reel 12 may also be connected to rods having other varieties of seat clamps other than the clamps depicted in FIGS. 5 and 6. For example, reel 12 may also be connected to a rod having hexagonal reel seat 54 with a hexagonally-shaped cross-section as shown in FIGS. 7A and 7B. In this embodiment, hexagonal collars 64 and 66 are provided on adjustable seat mounts 60 and 62. Hexagonal collars 64 and 66 swivel on adjustable seat mounts 60 and 62 so that they may be rotated independently of the adjustable seat mounts. Hexagonal cutout 56 which conforms to the surface of hexagonal reel seat 54 is provided on the bottom of reel 12. Arcuate slots 58 are provided on both ends of hexagonal cutout 56 and are configured to receive hexagonal collars 64 and 66. Clamp bar 68 also has hexagonal cutout 70 which is shaped to conform to the surface of hexagonal reel seat 54.

Reel 12 with hexagonal cutout 56 is installed on the rod similar to the embodiment shown and described in relation to FIGS. 3-6. Reel 12 is placed on hexagonal reel seat 54 and is mated with adjustable seat mount 60 so that hexagonal collar 64 is received within arcuate slot 58. Adjustable seat mount 62 is then rotated with respect to the rod until hexagonal collar 66 is received within arcuate slot 58. Clamp bar 68 is then attached as before.

FIG. 7B is a section view illustrating how hexagonal cutout 56 of reel 12 and hexagonal cutout 70 of clamp bar 68 conform to the surface of hexagonal reel seat 54 when the two components are clamped around hexagonal reel seat 54. The reader will appreciate that the cutouts can be made in many different shapes to conform to various reel seat surfaces. For example, the reader will easily envisage that cutouts can be provided to conform to any regular or irregular surface including but not limited to reel seats having triangular, square, oval, pentagonal, hexagonal, heptagonal, octagonal cross-sections.

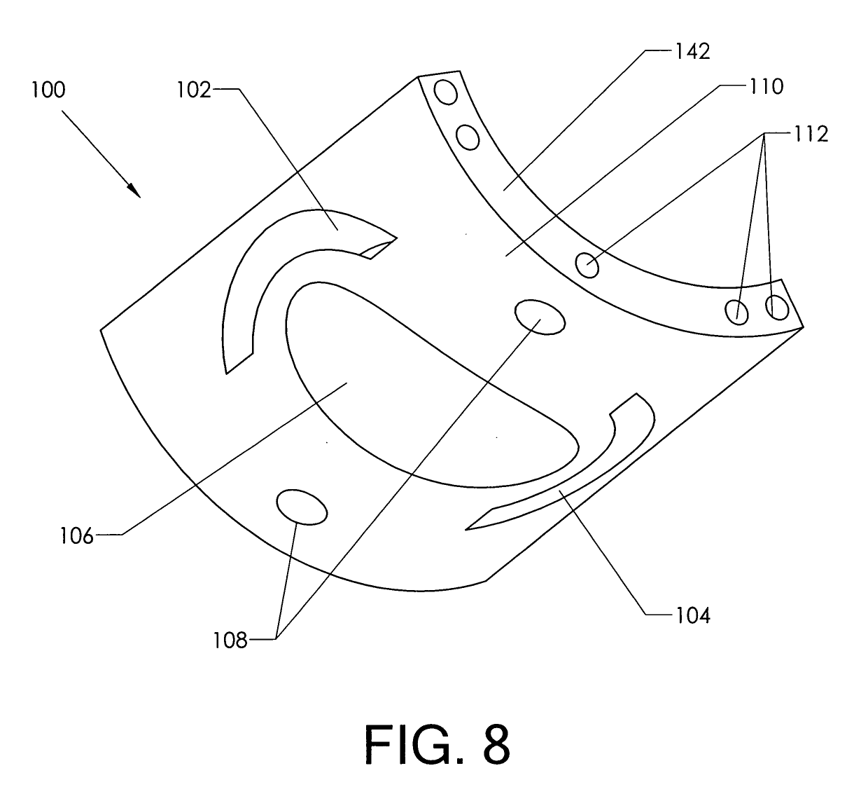

The foregoing description is directed to a new advantageous design for a fishing reel. Because saltwater fishing reels can be very expensive, many people may prefer not to replace a properly functioning reel with a new fishing reel despite the many advantages provided by the fishing reel of the present invention. As such, it is further contemplated that an attachment device could be provided for a standard saltwater fishing reel as a retrofit solution. FIG. 8 is a perspective view of such an attachment device which may be attached to a standard saltwater fishing reel. Reel attachment device 100 has curved surface 110 which mimics the curved shape of the fishing reel shown in FIG. 4A. Curved surface 110 faces the real seat of the fishing rod when the reel is attached to the rod. Curved surface 110 includes cylindrical cutout 106 and arcuate slots 102 and 104. These features have the same geometries as cutout 20 and arcuate slots 22 of the reel shown in FIG. 4A. Bores 108 are provided in curved surface 110 for attachment of a clamp bar. Side surface 142, includes bores 112 for fastening reel attachment device 100 to standard saltwater fishing reels. Bores 112 lie on both sides of reel attachment device 100. Bores 112 are placed at multiple locations along the side of reel attachment device 100 to accommodate most popular saltwater fishing reel designs.

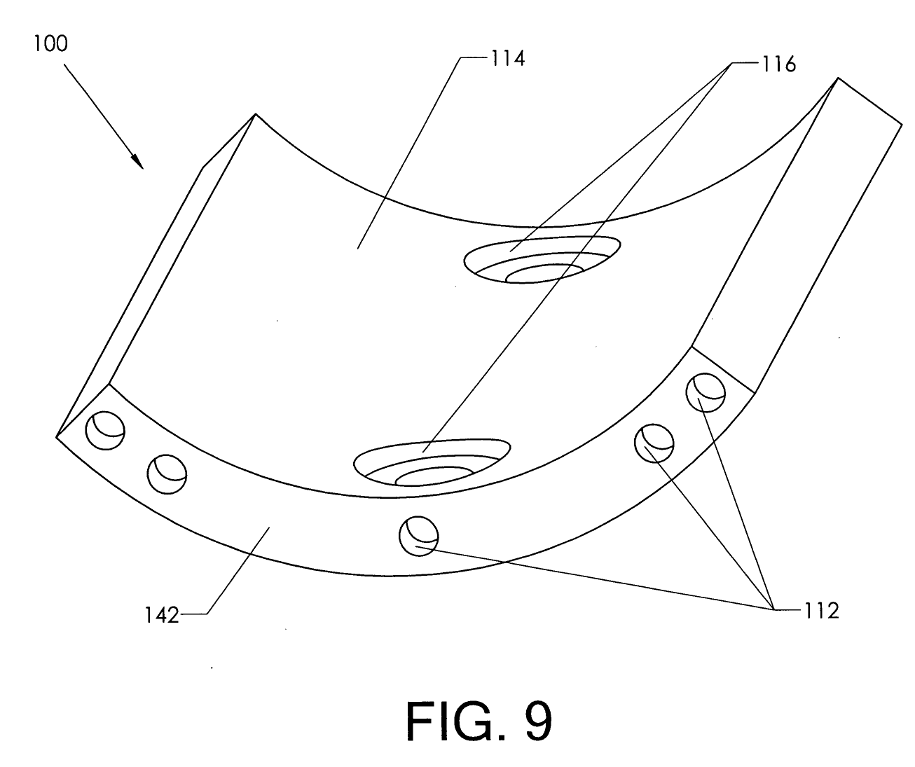

Turning to FIG. 9, reel attachment device 100 is shown from another perspective. Reel attachment device has spool-facing surface 114 opposite of curved surface 110. Counterbores 116 are provided in spool-facing surface 114 opposite bores 108. Counterbores 116 receive the heads of the bolts used when attaching the clamp bar.

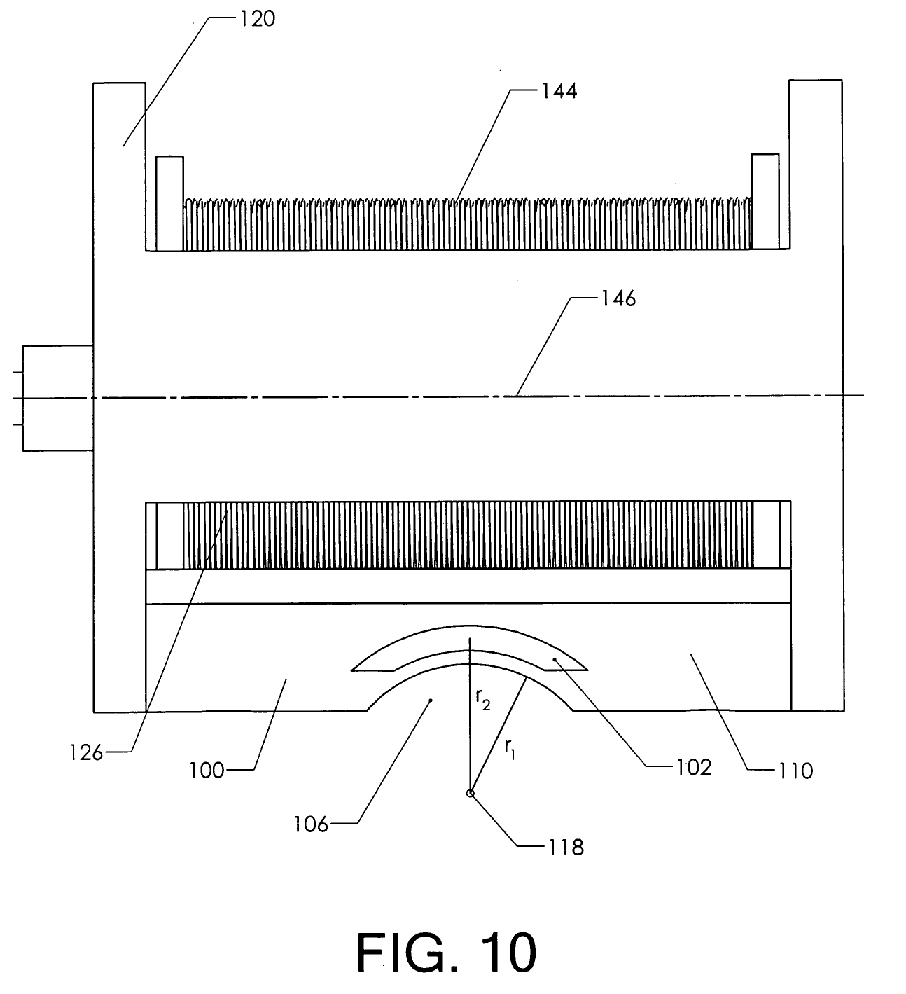

FIG. 10 shows attachment device 100 attached to a standard fishing reel. Reel 120 includes cutout 126 which faces the fishing rod when reel 120 is attached to the rod. Reel attachment device 100 is attached within cutout 126 by screws or other fasteners. Reel 120 includes spool 144 which holds a fishing line and rotates about spool axis 146. Cylindrical surface 110 wraps angularly about spool axis 146 when attached to reel 120. Cylindrical cutout 106 is provided in curved surface 110. Cylindrical cutout 106 forms another cylindrical surface, this cylindrical surface wrapping about central axis 118. Central axis 118 is separated from this cylindrical surface by a distance of r₁. Arcuate slot 102 also wraps around central axis 118 and has a depth extending parallel to central axis 118. Arcuate slot 102 is separated from central axis 118 by a distance of r₂. The reader will note that central axis 118 extends in a direction perpendicular to spool axis 146. Thus, the cylindrical surface formed by cylindrical cutout 106 lies perpendicular to the curvature of curved surface 110.

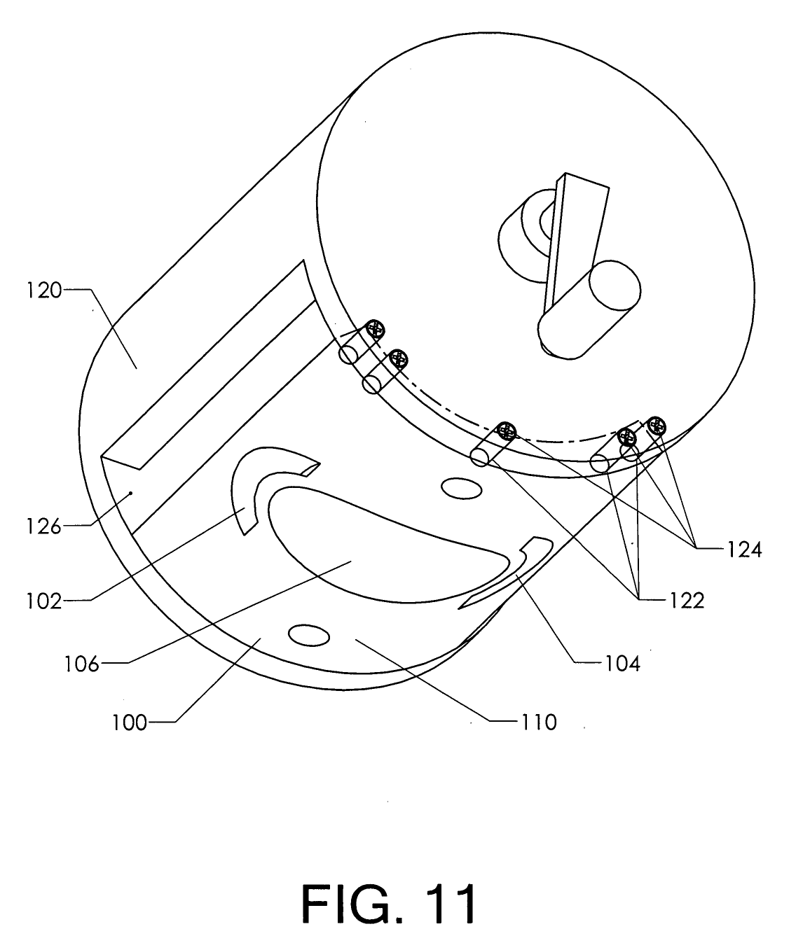

FIG. 11 shows reel 120 from another angle. Bores 124 are provided in the side wall of reel 120 near the bottom of the reel. Bores 124 align with bores 122 of reel attachment device 100 when reel attachment device 100 is situated within cutout 126. Screws 124 are then used to attach the two components together as shown.

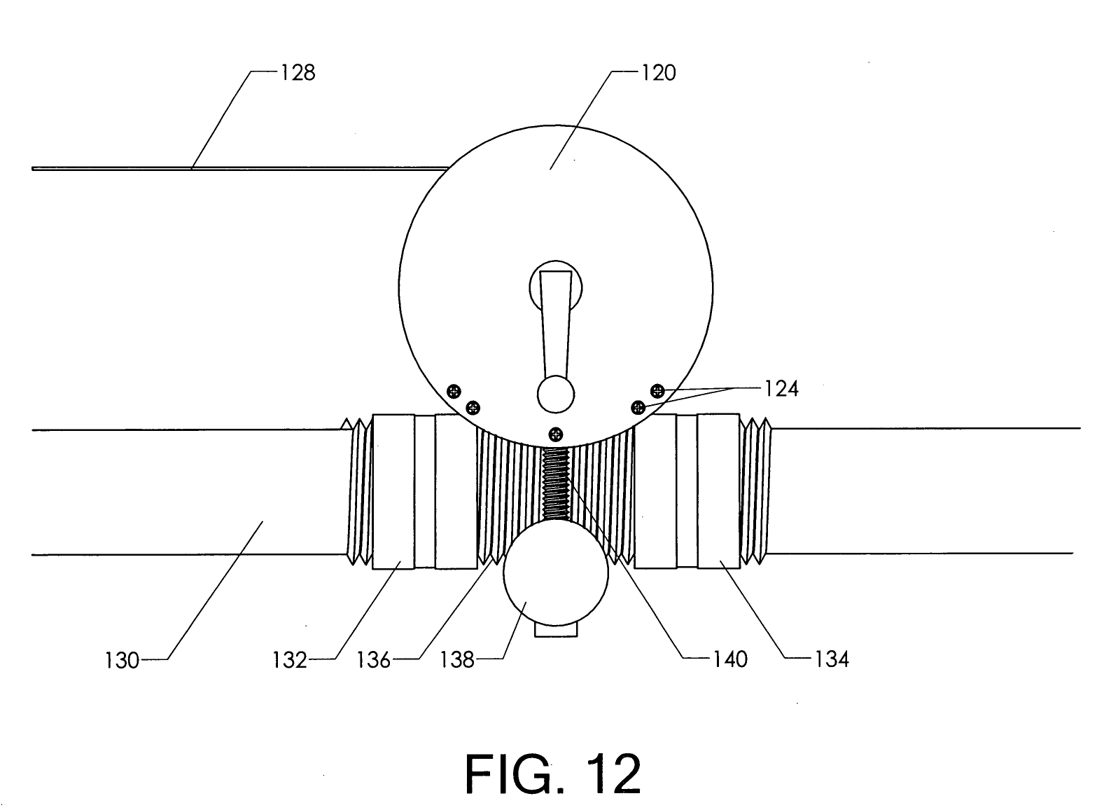

FIG. 12 shows how the attachment device may be used to attach a fishing reel to a fishing rod. Once reel attachment device 100 is attached to the bottom of the reel, reel 120 is placed on rod 130. Collars 132 and 134 are rotated along threaded portion 136 until they are received in arcuate slots 102 and 104. Bolts 140 are then inserted through clamp bar 138 and tightened such that rod 130 is clamped between reel 120 and clamp bar 138. Line 128 is then unspooled and fed through the loops on rod 130.

Although the preceding descriptions contain significant detail they should not be viewed as limiting the invention but rather as providing examples of the preferred embodiments of the invention. For example, arcuate slot 22 may be formed in shapes other than an arch. The mount assembly would function the same if arcuate slot 22 was rectangular although the dimensions of the rectangular slot would be different than the arch-shaped slot shown in the drawing views. Accordingly, the scope of the invention should be determined by the following claims, rather than the examples given.

Having described my invention, I claim:

1. A reel attachment device for attaching a fishing reel to a fishing rod, said fishing reel having a spool configured to rotate about a spool axis and a cutout configured to face said fishing rod when said fishing reel is attached to said fishing rod, said reel attachment device comprising:
a. a contoured object having
(1) a first end;
(2) a second end
(3) a convex curved surface extending between said first end and said second end, said curved surface configured to face said fishing rod when said contoured object is attached within said cutout of said fishing reel and said fishing reel is attached to said fishing rod, said curved surface configured to wrap angularly about said spool axis when said contoured object is attached within said cutout of said fishing reel;
(4) a reel-facing surface lying opposite of said curved surface, said reel-facing surface configured to face said fishing reel when said contoured object is attached within said cutout;
(5) a cylindrical cutout in said curved surface forming a portion of a cylindrical surface, said portion of said cylindrical surface wrapping angularly about a central axis, said central axis perpendicular to said spool axis when said contoured object is attached within said cutout of said fishing reel, said portion of said cylindrical having a forward end and a rearward end;
(6) a first arcuate slot in said curved surface proximate said forward end of said portion of said cylindrical surface thereby forming a first lip between said first arcuate slot and said forward end of said portion of said cylindrical surface, said first arcuate slot configured to wrap angularly about said central axis; and
(7) a second arcuate slot in said curved surface proximate said rearward end of said portion of said cylindrical surface thereby forming a second lip between said second arcuate slot and said rearward end of said portion of said cylindrical surface, said first arcuate slot configured to wrap angularly about said central axis.

2. The reel attachment device of claim 1, further comprising a fastener for attaching said contoured object to said reel within said cutout.

3. The reel attachment device of claim 1, further comprising a clamp bar.

4. The reel attachment device of claim 3, said clamp bar having a second cylindrical cutout.

5. The reel attachment device of claim 1, wherein said first arcuate slot and said second arcuate slot each have an opening circumscribed by a perimeter and a depth, said depth extending from said opening into said contoured object in a direction parallel to said central axis.

6. The reel attachment device of claim 1, wherein said first arcuate slot and second arcuate slot are concentric with said cylindrical cutout.

7. The reel attachment device of claim 1, wherein said first arcuate slot and second arcuate slot are concentric with said central axis.

8. The reel attachment device of claim 1, wherein said first arcuate slot and said second arcuate slot face in opposite directions such said first arcuate slot is configured to receive a first attachment collar provided on said fishing rod and said second arcuate slot is configured to receive a second attachment collar provided on said fishing rod.

9. The reel attachment device of claim 5, wherein said depth of said first arcuate slot extends towards said depth of said second arcuate slot.

10. The reel attachment device of claim 1, wherein said convex curved surface forms a second portion of a second cylindrical surface.

11. The reel attachment device of claim 2, said contoured object further having a first side surface extending between said first end and said second end, said first side surface having a bore configured to receive said fastener.

12. A reel attachment device manufactured by a process comprising the steps of:
a. obtaining a contoured object having a first end, a second end, and a convex surface extending between said first end and said second end, said convex surface wrapping angularly about a first axis;
b. milling a cylindrical cutout in said convex surface such that a portion of a cylindrical surface is formed in said convex surface, said portion of said cylindrical surface said wrapping angularly about a second axis, said second axis perpendicular to said first axis, said portion of said cylindrical surface having a forward end proximate said first end of said contoured object and a rearward end proximate said second end of said contoured object;
c. milling a first arcuate slot in said convex surface proximate said forward end of said portion of said cylindrical surface thereby forming a first lip between said first arcuate slot and said forward end of said portion of said cylindrical surface, said first arcuate slot concentric with said cylindrical cutout, said first arcuate slot extending angularly about said central axis; and
d. milling a second arcuate slot in said convex surface proximate said rearward end of said portion of said cylindrical surface thereby forming a second lip between said second arcuate slot and said rearward end of said portion of said cylindrical surface, said second arcuate slot concentric with said cylindrical cutout, said second arcuate slot extending angularly about said central axis.

13. The reel attachment device of claim 12, wherein said first arcuate slot and said second arcuate slot each have an opening circumscribed by a perimeter and a depth, said depth extending from said opening into said contoured object in a direction parallel to said central axis.

14. The reel attachment device of claim 12, wherein said first arcuate slot and said second arcuate slot face in opposite directions such said first arcuate slot is configured to receive a first attachment collar provided on said fishing rod and said second arcuate slot is configured to receive a second attachment collar provided on said fishing rod.

15. The reel attachment device of claim 13, wherein said depth of said first arcuate slot extends towards said depth of said second arcuate slot.

16. The reel attachment device of claim 12, wherein said convex surface forms a second portion of a second cylindrical surface.

17. The reel attachment device of claim 2, said contoured object further having a first side surface extending between said first end and said second end, said first side surface having a bore configured to receive a fastener.
